(19) United States
(12) Patent Application Publication
(10) Pub. No.: US 2003/0150326 A1
(43) Pub. Date: Aug. 14, 2003

(54) Multi-stage air cleaner fan system

(75) Inventor: James E. Chasen, West Haven, CT (US)

Correspondence Address: Barry E. Deutsch, Esq., Applica Consumer Products, Inc., 35 Thorpe Avenue, Suite 104, Wallingford, CT, 06492, US

(73) Assignee: HP INTELLECTUAL CORP., Wilmington, DE (US)

(21) Appl. No.: 10/073,465

(22) Filed: Feb. 11, 2002

(51) Int. Cl. B01D 46/00

(52) U.S. Cl. 95/273; 55/471

(57) ABSTRACT

A portable room air cleaner including a frame; at least one motor connected to the frame; at least two rotatable axial flow fans connected to the at least one motor; and a filter connected to the frame. The fans are rotated by the motor to additively build static air pressure in series for entry of the air into the filter.

### BACKGROUND OF THE INVENTION

1. Field of the Invention

The present invention relates to an air cleaning system and, more particularly, to a multi-stage fan system for use in an air cleaning system.

2. Brief Description of Prior Developments

Most room air purifiers use a “squirrel cage” blower type of fan system which comprises a centrifugal flow fan. A problem exists with these types of systems in that they are relatively noisy for the amount of air being moved. A conventional axial fan could deliver more air flow at lower noise levels, but a conventional axial fan cannot develop enough static pressure for effective use with a filter in a room air purifier. There is a desire to provide a room air purifier which can provide a greater air flow and greater static pressure at a given noise level than conventional room air cleaners.

### SUMMARY OF THE INVENTION

In accordance with one aspect of the present invention, a portable room air cleaner is provided including a frame; at least one motor connected to the frame; at least two rotatable axial flow fans connected to the at least one motor; and a filter connected to the frame. The fans are rotated by the motor to additively build static air pressure in series for entry of the air into the filter.

In accordance with another aspect of the present invention, a portable room air cleaner is provided comprising a frame; a single motor connected to the frame; at least two spaced fans operably connected to the single motor; and a filter connected to the frame.

In accordance with one method of the present invention, a method of moving air in a portable room air cleaner is provided comprising steps of rotating a first fan by a motor to propel air through a first stage of the portable room air cleaner; and rotating a second fan by the motor to propel air from the first stage through a second stage of the portable room air cleaner and into a filter of the air cleaner. The sequential multistage propulsion of air allows an increase in static air pressure for entry of the air into the filter without substantial noise from the rotating first and second fans.

### BRIEF DESCRIPTION OF THE DRAWINGS

The foregoing aspects and other features of the present invention are explained in the following description, taken in connection with the accompanying drawings, wherein:

FIG. 1 is a perspective view of a room air cleaner incorporating features of the present invention;

FIG. 2 is a cross sectional view of the air cleaner shown in FIG. 1;

FIG. 3 is a perspective view of the air cleaner shown in FIG. 1 with the inlet cover removed;

FIG. 4 is a schematic cross-sectional view of an alternate embodiment of the present invention; and

FIG. 5 is a cross sectional view of another alternate embodiment of the present invention.

### DETAILED DESCRIPTION OF THE PREFERRED EMBODIMENTS

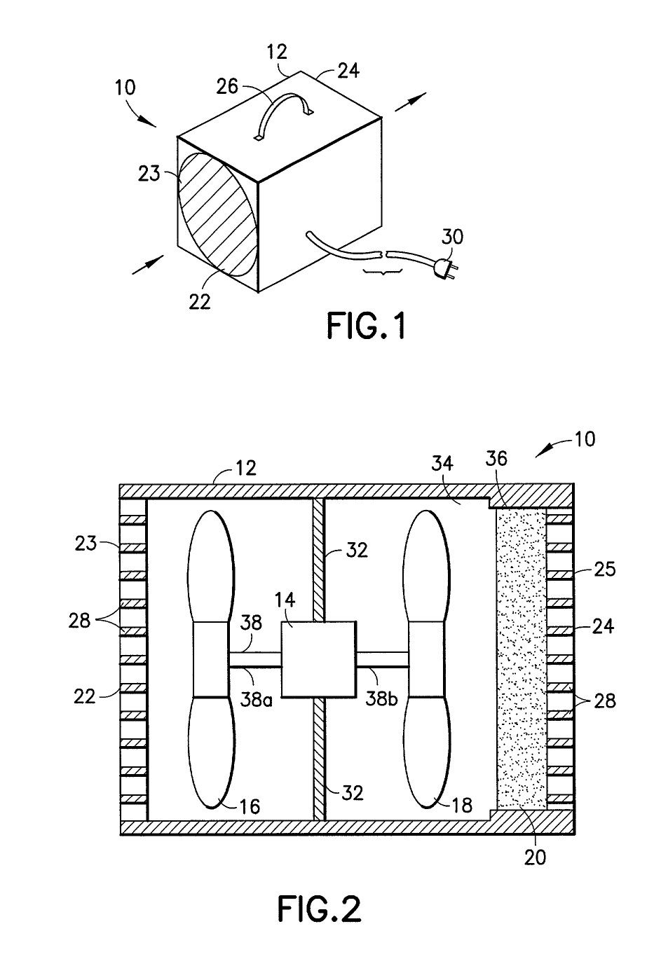

Referring to FIG. 1, there is shown a perspective view of a room air cleaner 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

Referring also to FIG. 2, the room air cleaner 10 generally comprises a frame 12, a motor 14, two fans 16, 18 and a filter 20. In alternate embodiments, the room air cleaner could comprise additional or alternative components. In the embodiment shown, the room air cleaner 10 is a portable room air cleaner intended to be relatively easily relocated by a user to a desired position in a room. However, in alternate embodiments, the air cleaner 10 could be adapted to be located in a window opening or other semi-fixed or fixed position, such as in a non-portable air cleaner.

The frame 12 generally comprises an inlet 22, and outlet 24, and a carry handle 26. In an alternate embodiment, the carry handle 26 might not be provided. In the embodiment shown, the inlet 22 is located at an opposite end of the frame from the outlet 24. However, in alternate embodiments, the outlet could be located at any suitable side(s) of the frame. In the embodiment shown, the frame 12 establishes a generally straight air conduit path between the inlet 22 and the outlet 24. However, in alternate embodiments, the air conduit path through the frame 12 could be non-straight. In the embodiment shown, the frame 12 is generally adapted to be located on a floor, but could be located on a desktop or other suitable location.

In the embodiment shown, the inlet 22 and outlet 24 comprise removable covers 23, 25. However, in alternate embodiments, the covers 23, 25 might not be removable. The covers 23, 25 each comprise protective gratings 28 with holes therethrough to allow air to enter and exit the frame 12, but prevent a user's fingers from inadvertently entering into the frame 12. In alternate embodiments, the inlet and outlet could have any suitable type of shapes for allowing air to flow therethrough. The frame 12 forms a main air flow channel 34 and a filter receiving area 36 between the inlet 22 and the outlet 24. The filter receiving area 36 is located proximate the outlet 24.

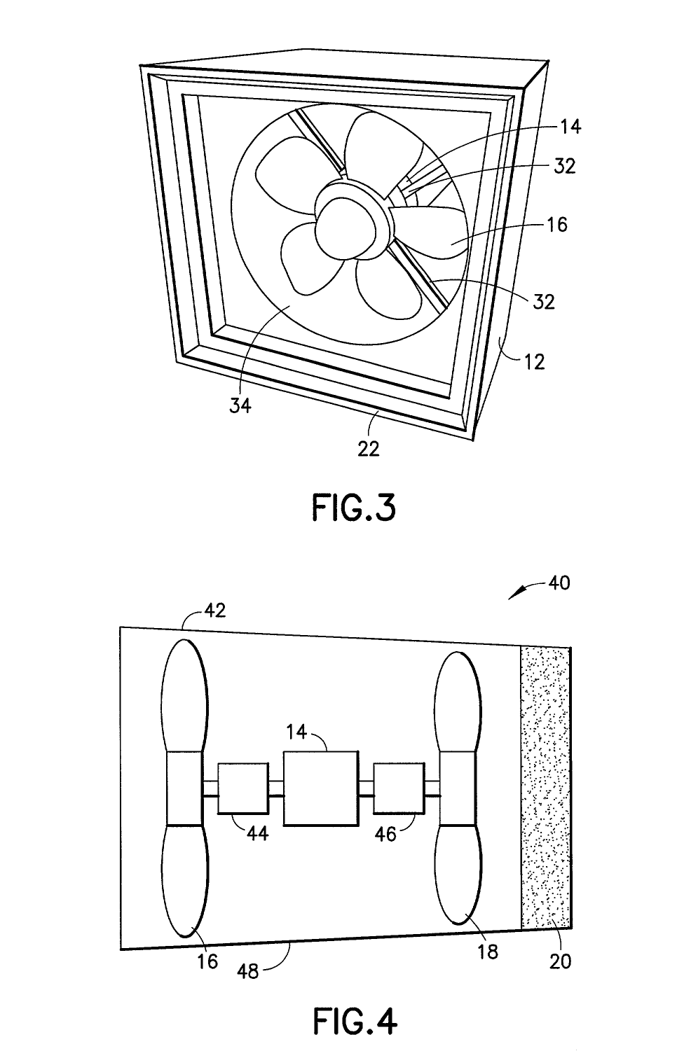

Referring also to FIG. 3, the inlet end of the air cleaner 10 is shown with the inlet cover 23 removed. The motor 14 is preferably an electric motor which can be attached to an electrical outlet by a plug 30. The motor 14 is fixedly connected to the frame by support brackets 32. The support brackets 32 allow the motor 14 to be supported in the center of the main air flow channel 34. However, in alternate embodiments, the motor 14 could be supported on the frame 12 in any suitable position and in any suitable manner.

The motor 14 comprises a drive shaft 38. In the embodiment shown, the drive shaft 38 extends from the motor 14 on two opposite sides. The first fan 16 is directly fixedly attached to a first end 38a of the drive shaft. The second fan 18 is directly fixedly attached to the opposite second end 38b of the drive shaft. Thus, as the motor 14 rotates the drive shaft 38, the motor will rotate both the first and second fans 16, 18.

The first and second fans 16, 18, in the embodiment shown, are both axial flow fans. In a preferred embodiment, the fans 16, 18 have “high pitch” axial fans blades such as having a pitch of about 30%-40%. However, any suitable pitch could be provided. The two fans 16, 18 could be substantially the same as each other, or could be different from each other. Any suitable type of axial flow fans could be used. For example, the fans could comprise three, five or seven fan blades. In the embodiment shown, the main air flow channel 34 has a substantially uniform shape along its length. However, in an alternate embodiment, the cross sectional flow path of the main air flow channel 34 could change along its length, such as becoming narrower or larger proximate the second fan 18. In a preferred embodiment, the first fan 16 has a pitch of about 30% and the second fan has a pitch of about 40%, but any suitable percentages or ratio of percentages could be provided.

As noted above, the frame 12 comprises a filter receiving area 36. The filter receiving area 36 is adapted to removably receive the filter 20. In the embodiment shown, the filter 20 is preferably a cartridge filter which can be replaced by removing the cover 25. However, in alternate embodiments, the filter 20 could be removably connected to the frame 12 in any suitable manner. Further, the filter 20 may comprise a plurality of removable filter elements. For example, a first filter element might be adapted to remove odors and a second filter element might be adapted to remove small particulate matter. The filter 20 is located in front of the outlet 24 such that air passing through the main air flow channel 34 must pass through the filter 20 in order to exit through the outlet 24. The filter 20 could comprise any suitable type of filter. For example, the filter 20 could comprise a paper filter element, and/or a polymer mesh filter element and/or an activated carbon filter element. The filter element could comprises a high-efficiency particulate arrest (HEPA) filter.

As the first fan 16 is rotated by the motor 14, the first fan 16 pulls air through the inlet 22, into the main air flow channel 34, and propels the air towards the second fan 18. As the air is pushed by the first fan 16 towards the second fan 18, the velocity of the air increases and the static pressure of the air also increases. This forms a first stage for increasing the velocity and static air pressure of the air as it travels through the air cleaner. As the air comes to the second fan 18, the second fan 18 propels the air towards the filter 20. This forms a second stage for increasing the velocity and static air pressure of the air as it travels through the air cleaner. Thus, the two fans 16, 18 form a multistage fan system for increasing the velocity and static air pressure of the air before it reaches the filter 20. The increase in static air pressure and velocity from the multi stage fan system imparts sufficient force on the air as its engages the filter 20 such that the air can pass through the filter 20 and exit the air cleaner through the outlet 24.

The present invention can provide more air flow and static pressure at a given noise level than a single stage axial fan system. This makes it particularly advantageous for use in an air purification system which is intended to move large quantities of air through a filter with the least possible noise. An axial fan system can move a larger quantity of air at a given noise level than a “squirrel cage” blower type of fan system. Thus, for a given noise level, the present invention can move a larger quantity of air than a “squirrel cage” blower type fan system and, can move more air flow and provide greater static pressure then a single stage axial fan system. Greater static air pressure can increase the ease at which the air passes through the filter 20. A greater quantity of air flow through the cleaner 10 enables the cleaner 10 to be smaller in volume or size than a conventional air purifier, but with the same cleaning capacity and without an increase in the noise output from the cleaner. Alternatively, the air cleaner 10 could be adapted to provide a same quantity of air flow therethrough as a conventional air purifier, but with a smaller size and decreased noise output.

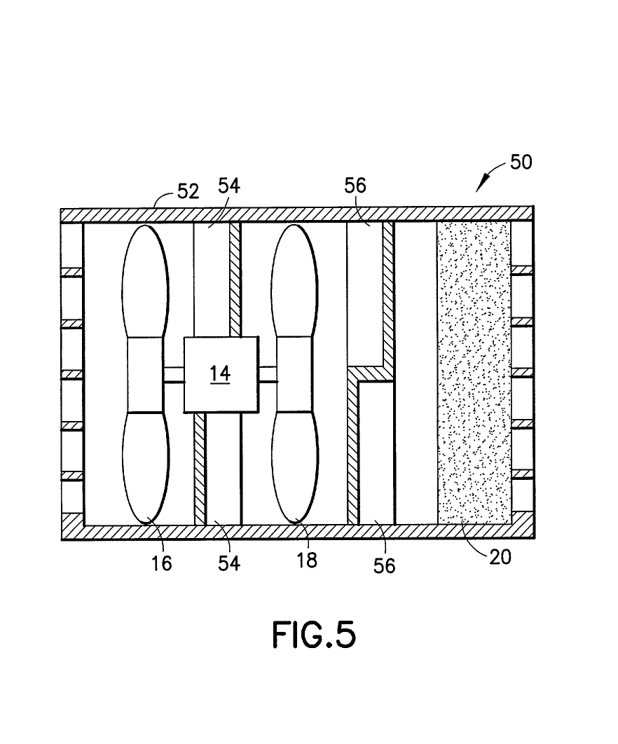

Referring now to FIG. 4, a schematic diagram of components of an alternate embodiment of the present invention are shown. In this embodiment the air cleaner 40 generally comprises a frame 42, the motor 14, the fans 16, 18, the filter 20, and two transmissions 44, 46. In this embodiment, the frame 42 forms a main air flow channel 48 which decreases in size along its length. This can help to increase static pressure rise along the length of the channel 48. The two fans 16, 18 are connected to the opposite ends of the drive shaft of the motor 14 by the two transmissions 44, 46. In an alternate embodiment, only one of the fans might be connected to the drive shaft by a transmission. The two transmissions 44, 46 allow the fans 16, 18 to be rotated at different rotational velocities relative to each other. The two transmissions 44, 46 can also maximize the driving power of the motor 14 for the different force levels encountered by the two fans 16, 18 as they propel air.

Referring now to FIG. 5, another alternate embodiment of the present invention is shown. In this embodiment, the air cleaner 50 generally comprises a frame 52, the motor 14, the two fans 16, 18 and the filter 20. In this embodiment the motor 14 is connected to the frame 52 by a first set of air vanes 54. The first vanes 54 could be integrally formed with the frame 52. The first vanes 54 are adapted to redirect air exiting from the first fan 16 for a more efficient flow into the second fan 18. This can help to reduce static pressure losses and increase air velocity.

The air cleaner 50 also comprises a second set of air vanes 56. The second air vanes 56 could be integrally formed with the frame 52. The second vanes 56 are adapted to redirect air exiting from the second fan 18 for a more efficient engagement with the front face of the filter 20. In a preferred embodiment, the air exiting from the second air vanes 56 will engage the front face of the filter 20 substantially perpendicular to the front face. In an alternate embodiment, the air cleaner might comprise only one set of air redirection vanes. In another alternate embodiment, such as when the air cleaner comprises more than two fans, the air cleaner could comprise more than two sets of air redirection vanes. In another type of alternate embodiment, the air cleaner could comprise more than one motor and, could comprise more than one filter.

The present invention can use two or more “high pitch” axial fan blades which are driven off a common motor drive shaft. Air can be drawn into the inlet opening, preferably unobstructed by any filters or fine screen. The air can then enter the first stage fan whereby its velocity and static pressure can rise. The air can then enter the second stage fan which results in a further increase in velocity and static pressure. This provides enough force to push the air through a filter located on the output side of the unit. Test results have shown an increase of about 21%-35% in the air flow, depending upon the specific filter tested, and about 40% in static pressure verses a single axial fan system when compared at the same sound level. In an alternate embodiment, more than two fan stages could be provided. The blade pitch of the fan blades at the inlet verses the outlet could be varied. The present invention could also be used with air vanes to optimize air flow. The multi-stage fan system can also be used as a cooling fan by providing a greater air flow quantity when compared to a single stage fan of similar size and noise level.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A portable room air cleaner comprising:
a frame;
at least one motor connected to the frame;
at least two rotatable axial flow fans connected to the at least one motor; and
a filter connected to the frame,
wherein the fans are rotated by the at least one motor to additively build static air pressure in series for entry of air into the filter.

2. A portable room air cleaner as in claim 1 wherein the least one motor comprises a single motor.

3. A portable room air cleaner as in claim 2 wherein the at least two rotatable axial flow fans are connected to a single drive shaft of the single motor.

4. A portable room air cleaner as in claim 3 wherein the fans are connected to opposite ends of the drive shaft.

5. A portable room air cleaner as in claim 4 wherein the fans are directly connected to the drive shaft.

6. A portable room air cleaner as in claim 4 wherein at least one of the fans is connected to the drive shaft by a transmission system.

7. A portable room air cleaner as in claim 1 wherein two of the axial flow fans are connected to a same motor of the at least one motor, and at least one of the fans is connected to the motor by a transmission system.

8. A portable room air cleaner as in claim 1 further comprising air redirecting vanes connected to the frame and located between two of the axial flow fans.

9. A portable room air cleaner as in claim 1 further comprising air redirecting vanes connected to the frame and located between one of the axial flow fans and the filter.

10. A portable room air cleaner comprising:
a frame;
a single motor connected to the frame;
at least two spaced fans operably connected to the single motor; and
a filter connected to the frame,
wherein the portable room air cleaner comprises an air flow path from a first one of the fans, then to a second one of the fans, and then to the filter.

11. A portable room air cleaner as in claim 10 wherein the at least two fans are connected to opposite ends of a drive shaft of the motor.

12. A portable room air cleaner as in claim 11 wherein the fans are directly connected to the drive shaft.

13. A portable room air cleaner as in claim 11 wherein at least one of the fans is connected to the drive shaft by a transmission system.

14. A portable room air cleaner as in claim 10 further comprising air redirecting vanes connected to the frame and located between two of the fans.

15. A portable room air cleaner as in claim 10 further comprising air redirecting vanes connected to the frame and located between one of the fans and the filter.

16. A portable room air cleaner as in claim 10 wherein at least one of the fans is an axial flow fan.

17. A portable room air cleaner as in claim 16 wherein at least two of the fans are axial flow fans.

18. A method of moving air in a portable room air cleaner comprising steps of:
rotating a first fan by a motor to propel air through a first stage of the portable room air cleaner; and
rotating a second fan by the motor to propel the air from the first stage through a second stage of the portable room air cleaner and into a filter of the air cleaner,
wherein the sequential multistage propulsion of the air by more than one fan allows an increase in static air pressure for entry of the air into the filter without a substantial increase in noise versus a single rotating fan.

19. A method as in claim 18 wherein the first fan and the second fan are directly connected to opposite ends of a drive shaft of the motor, and rotation of the drive shaft rotates the first and second fans.

20. A method as in claim 18 wherein the first and second fans comprise axial flow fans, and the steps of rotating the first and second fans propels the air axially from the first fan to the second fan and then axially from the second fan to the filter.
